(19) United States
(12) Patent Application Publication
(10) Pub. No.: US 2007/0161490 A1
(43) Pub. Date: Jul. 12, 2007

(54) PROTECTIVE DEVICE

(76) Inventor: Priti Srivastava, White Plains, NY (US)

Correspondence Address: LACKENBACH SIEGEL, LLP, LACKENBACH SIEGEL BUILDING, 1 CHASE ROAD, SCARSDALE, NY, 10583, US

(21) Appl. No.: 11/537,596

(22) Filed: Sep. 29, 2006

Related U.S. Application Data
(60) Provisional application No. 60/721,765, filed on Sep. 29, 2005.

(51) Int. Cl. B31B 1/00

(52) U.S. Cl. 493/464

(57) ABSTRACT

A novel form of a transportable consumer protective device is provided. In one aspect, the device provides a contact surface securely retained on a portion of supportive device, such as a pillow. Alternative embodiments include adaptations with a reduced friction form to minimize user hair damage or adaptations with absorptive materials that speed user hair drying after washing. A further aspect of the present invention provides temporary protective covers to head rests during travel for user safety.

### CROSS REFERENCE TO RELATED APPLICATIONS

The present invention relates to and claims, priority from U.S. Provisional Patent Application Ser. No. 60/721,765, filed Sep. 29, 2005, the entire contents of which are herein incorporated by reference.

### BACKGROUND OF THE INVENTION

1. Field of the Invention

The present invention relates to a protective device. More specifically, the present invention relates to a protective device for covering padded items and quilted items while minimizing injury to hair and the underlying item. A further aspect of the present invention allows ready adaptation of these protective consumer products to alternative design themes.

2. Description of the Related Art

The related art involves unitary pillow shams for covering a plurality of pillows with a continuous protective unit providing a continuous bounding seal. As seen in U.S. Pat. No. 6,427,268 to Davis, a pillow sham product is provided from a continuous woven material including a plurality of complex hems so as to define multiple internal pillow-receiving bounded regions.

The overall design of the Davis invention provides a continuous-pillow appearance to the combined pillow-unit that is designed to camouflage its multi-pillow contents and span a bet from side to side. The use of the Davis construction provides important benefits over common conventional pillow shams formed from simple lace squares draped over pillows.

What is not appreciated by the prior art is the need for a rapidly removable and transportable protective cover for pillows.

What is also not appreciated by the related art is the need for a temporary pillow cover that is securely positionable and may be optionally equipped with a low-friction surface to minimize hair damage for a user or with an absorptive surface to speed damp hair drying.

What is also not appreciated by the related art is the need for a personally transportable pillow cover that may be readily removed for transport and yet allows ready use on a variety of pillow shapes during commercial or other travel, for example as self-supporting head rest cover. The need for such a personally transportable pillow cover to minimize exposure to disease, microbes, or pests (lice) in airliner, train, truck, and bus head rests is not appreciated within the known art.

Finally, what is not appreciated by the related art is the need for a product that will readily and removably cover an in-place pillow sham (pillow cover) that is rough or damaging to hair or that provides a decorative appearance.

Accordingly, there is a need for an improved pillow protective device that is readily adaptive to at least one of the needs noted above.

### OBJECTS AND SUMMARY OF THE INVENTION

One aspect of the present invention is to provide a device that reduces hair breakage from snagging when sleeping.

It is another aspect of the present invention to provide a device that feels comfortable during use and prevents damage to an underlying supportive pillow.

It is another aspect of the present invention to provide a device that can be slipped on top of existing pillow shams and thereby minimize interference with a consumer's existing sheet and pillow sets.

It is another aspect of the present invention to provide an easy to manufacture hair and pillow protecting device.

It is yet another aspect of this invention to provide a hair protecting device that can be easily packed for travel and provides substantive protection during travel as a portable protective device.

In yet a further aspect of the present invention, those of skill in the art will recognize that adaptations may be made to employ the present device to provide an absorptive and/or water resistant surface so as to aid hair trying while also minimizing surface resistance. Such a padded and absorptive product may be similarly used to prevent damage in spas and homes to existing decorative shams.

Similarly, it is possible for employing the present invention as a ready system for updating a user-furniture look wherein a pattern used may complement and augment an existing pillow pattern and thereby reduce a need to acquire new pillows and new furniture.

Another object of the present invention is to provide a consumer product that is readily installable on and removable from an in-place pillow-sham product.

The present invention relates to a novel form of a transportable consumer protective device is provided. In one aspect, the device provides a contact surface securely retained on a portion of supportive device, such as a pillow. Alternative embodiments include adaptations with a reduced friction form to minimize user hair damage or adaptations with absorptive materials that speed user hair drying after washing. A further aspect of the present invention provides temporary protective covers to head rests during travel for user safety.

According to an embodiment of the present invention there is provided a protective device, for engaging an external cushion member and protecting a users head, comprising: at least a first pillow sleeve member having an inner surface and an outer surface, means for securely engaging the first pillow sleeve member to the external cushion member, thereby minimizing displacement relative thereto during a use by the user, and the outer surface being at least one of an increased friction surface and a reduced friction surface, whereby the protective device is readily adapted to a user demand.

The above, and other objects, features and advantages of the present invention will become apparent from the following description read in conduction with the accompanying drawings, in which like reference numerals designate the same elements.

### BRIEF DESCRIPTION OF THE DRAWINGS

FIG. 1 shows a first embodiment of a hair protecting device according to one embodiment, installed on a pillow covered with an over-sham product.

FIG. 2 is an embodiment of a protective device with alternative support straps.

FIG. 3 is an alternative embodiment of a protective device with an alternative support means.

FIG. 4 is an alternative embodiment of a protective device with an alternative support structure.

FIG. 5 is an embodiment of a protective device with a yet further alternative support structure.

FIG. 6 is another embodiment of a protective device formed for ready storage and transport between uses.

FIG. 7 is another embodiment of a protective device with ready release and adjustment structures for support.

FIG. 8 is a further embodiment of a protective device with an alternative securing structure.

FIG. 9 is an additional embodiment of a protective device with an adaptive securing structure.

FIG. 10 is a perspective view of an adaptive use of the embodiment in FIG. 2 during travel for user protection.

### DETAILED DESCRIPTION OF PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

In brief summary of one aspect of the invention, a sleeve is provided over an existing pillow sham that enshrouds a pillow. The original pillow sham commonly shows at the periphery of the hair-protecting sleeve thus preserving the look of the existing pillow and sheet set during non-sleep periods when the over-sham is removed. The smooth surface of the hair protecting sleeve reduces hair breakage during sleep from snagging on a rough pillow sham. Additionally, the sleeve can be easily packed for travel and slipped over hotel pillow cases (a form of enshrouding sham), for instance. The hair protecting surface of this invention is an easy to manufacture, easy to use and easy to care for item that can help both men and women take better care of their hair.

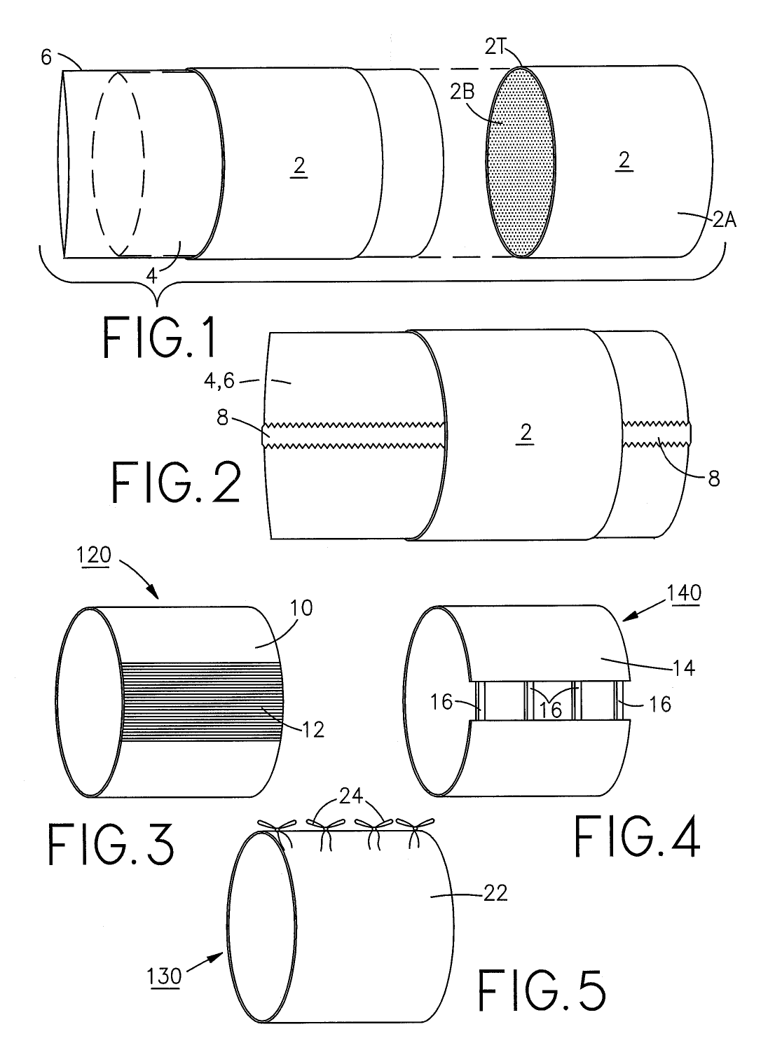

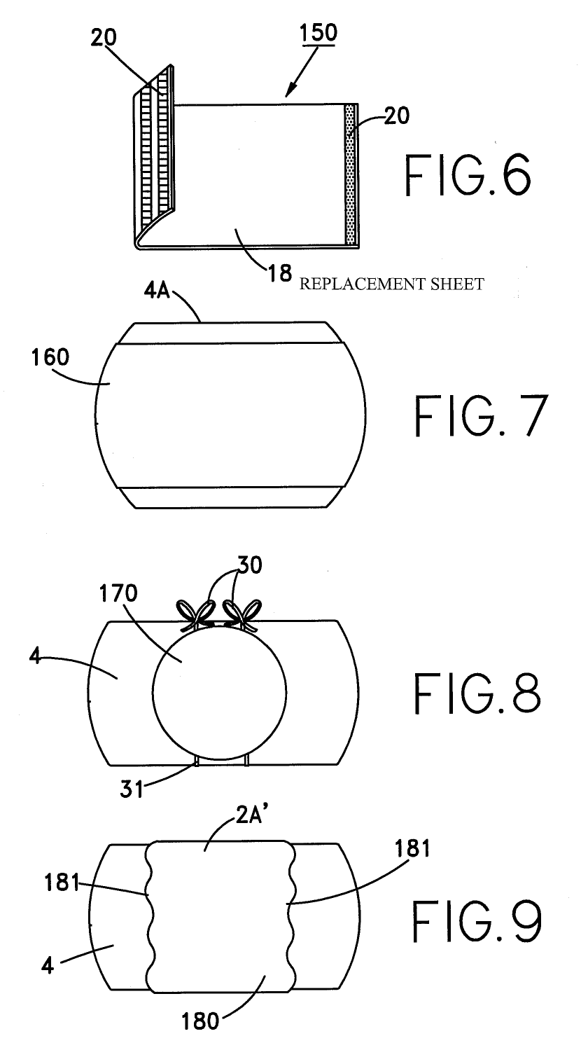

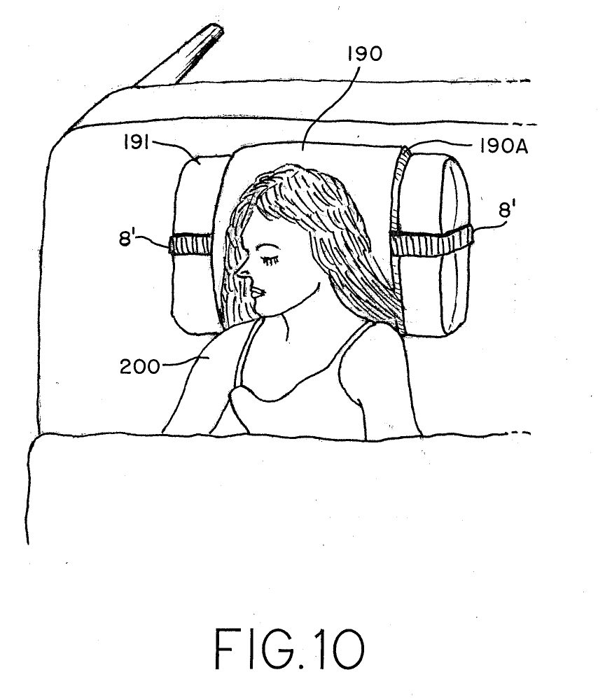

Referring now to FIG. 1, a pillow 4 is enshrouded by a pillow sham or pillow case or both at 6. During common use pillow 4 is retained within pillow sham or pillow case 6. In one embodiment of the present invention, a pillow sleeve 2 is provided having a wall thickness 2T, shown here is being a thin textile material such as satin.

Pillow sleeve 2 is formed in one aspect as a continuous bounding member having opposing open ends for receiving and sliding over pillow 4 for easy installation and rapid removal for cleaning and washing.

In a preferred embodiment, pillow sleeve 2 is provided of a smooth silky or satiny material on an outer surface 2A thereof so as to provide a lower friction contact surface for contacting a user's hair when a user's head rests upon pillow 4. An inner surface 2B is preferably provided of a relatively rough material so as to encourage pillow sleeve 2 to remain in place on pillow 4 during extended use.

While no requirement is provided herein for an inner surface 2B to encourage engagement with the outer surface of the pillow 4/sham 6 combination, it is advantageous to prevent pillow sleeve 2 from pivoting about the outer perimeter of the pillow 4/sham 6 combination. Similarly, while there is no specific requirement for outer surface 2A to be particularly of lower friction materials, the present invention recognizes that certain individuals have particularly fragile hair follicles, particularly where long hair-stiles are used, such that an individual with long and fragile hair may easily break the hair follicles and damage their hair when resting upon a conventional pillow sham 6 and pillow 4.

For installation, as shown in FIG. 1, a user simply compacts the pillow 4/sham 6 combination to allow the user to slid pillow sleeve 2 to a desire position before puffing pillow 4 into a desired shape and engaging the inner engaging surface 2B of pillow sleeve 2.

While the present embodiment of pillow sleeve 2 is shown with only two layers, the present invention envisions that alternative constructions are readily within the scope of the present disclosure. As an example, pillow sleeve 2 may be constructed with additional padding or absorptive materials between inner and outer surfaces 2A, 2B to provide additional functionality—for example to protect a pillow from a certain user-hair conditioning treatment or hair dye. This additional functionality may be realized employing a padded pillow sleeve 2 to increasing the padding in a minimally padded pillow 4. Alternatively, pillow sleeve 2 may be employed with padding on a head support (not shown) such as a chair back or sauna couch that has minimal or no padding so that the head support gains padding and the user is similarly protected from contact.

Additionally, it will be recognized by those of skill in the art, that material selection for pillow sleeve 2 may, depending upon user circumstances, require that a soft, yet absorptive material such as terry cloth, cotton, or velvet may be used where hair cushioning is desired over the reduced friction provided by satin or silk materials. An enhanced cushioning circumstance may be desired where a user is not rolling or moving during sleep but is, for example, simply reading a book and conscious, thereby maintaining a non-hair-straining position requiring only absorption or cushioning.

Similarly, it is envisioned that pillow sleeve 2 may contain a moisture-proof barrier between inner and outer surfaces 2A, 2B so as to further protect pillow 4 from unintended damage or saturation. As an example, a pillow sleeve 2 may be provided with such a barrier to prohibit a user's sweet from penetrating pillow 4 during a hot summer day.

It is similarly envisioned that pillow sleeve 2 may be employed during travel, where for example the cleanliness of pillow sham 6 or pillow 4 are suspect. Under these circumstances, a use may simply install pillow sleeve 2 covering the suspect surfaces for user protect. It is additionally envisioned, that inner surface 2B may be provided with an anti-organism or biological shield minimizing the transfer of disease to a traveling user.

Referring now to FIG. 2, the combination of pillow 4 with sham 6 is provided. In this embodiment, pillow sham 2 may be provided with additional securing means 8, such as elastic bands or ribbons or snaps, buttons, or hooks, so as to positively engage either pillow 4 or pillow sham 6 to prevent unintended displacement relative thereto.

The present invention envisions that a particularly useful functionality provides alternative means for securing pillow sleeve 2 to an inner pillow 4 that are readily selectable depending upon a user's convenience and circumstances.

For example, as seen in FIG. 3, a pillow sleeve 120 includes a continuous outer member 10, for example made of satin or smooth cotton, joined at respective ends by a band of elastic stretch material 12. This band of material enables pillow sleeve 120 to snugly fit about a variety of useful pillow widths. Due to the variations of consumer demand, band 12 may be readily positioned at any location about pillow sleeve 120 without functionally interfering with at least one of the goals noted above.

Referring now to FIG. 4, an alternative pillow sleeve 140 is provided as discussed above, but ends of sleeve 140 are joined by bands 16 of stretchable 16 which may be positioned to bridge the gap between the ends of sleeve 140 and so provide the most user comfort without interfering with the functional aspects of pillow sleeve 4 and providing a smooth surface for contacting a user's hair.

Similar to the above, and referring now to FIG. 5, a pillow sleeve cover 130 consists of a continuous sleeve portion 22 secured at its ends with ties 24. Ties 24 are used to scrunch portion of sleeve 22 so as to reduce it's predetermined length and fit snugly on a variety of conventional consumer pillow widths. An aspect of this present embodiment is that ties 24 may be anywhere along the length of sleeve portion 22 for enhancing user comfort without interfering with the functional aspects of the sleeve—minimizing hair damage and improving user comfort without damaging the underlying pillow.

Referring now to FIG. 6, an alternative pillow sleeve 150 is providing have a lengthwise and open construction. At opposing sides of sleeve 150 are formed closing and engaging means 20, such as Velcro strips, loop tapes, buttons, hooks, ties, zippers, and laces. While sleeve 150 is shown having a rectangular shape, it is envisioned that other shapes (square for example) may be employed without departing from the scope of the present disclosure so as to provide an improved user comfort adaptable to unusual pillow 4 shapes without interfering with the above discussed function of the present invention.

Referring now to FIG. 7, an alternative embodiment of the present invention provides a pillow sleeve 160 engaging an oddly shaped pillow 4A formed as an ovoidal shape. Pillow sleeve 160 is provided as a continuous bounding member about pillow 4A and is constructed from a continuous elastomeric material such as elastic, lycra, neoprene, or poly-foam material enabling substantial stretching while preserving functionality to respond to at least one of the needs noted above.

Referring further now to FIG. 8, in yet another embodiment, a pillow sleeve 170 is provided with a minimized size providing hair protection on only one user-surface of pillow 4. An extending member 31 from sleeve 170 passes around pillow 4 and engages a corresponding extending member 31 from an opposing side of sleeve 170 forming a tied loop 30. As can be seen from the depiction, it is readily possible that a small travel-sized pillow sleeve 170 may be readily transported for user need at a variety of circumstances or to cover other surfaces normally used by the public, for example train head rests, or those head rests in rental cars, airplanes, boats, and other forms of public transport.

Referring now to FIG. 9 with yet a further embodiment of the present invention provides a pillow sleeve 180 securely bounding pillow 4 and constructed with a flowing user edge 181, wherein a material forming sleeve 180 contains side-absorption regions bounding an inner reduced friction region there between. As a consequence, this present construction allows an outer surface 2A′ to contain a combination of high and low friction materials and minimal absorption and improved absorption materials as a demonstration of the versatility of the present design to consumer demand.

Referring now to FIG. 10, a passenger 200 is reclining on a publicly provided headrest 191, here shown on a train. As noted earlier with an embodiment similar to that shown in FIG. 2, an alternative pillow sleeve member 190 including a cushioned thickness 190 and protective front and inner surfaces has been installed by user 200. As a consequence, the hair of user 200 is readily cushioned during extensive travel while being protected from a potentially dirty headrest. As a complementary benefit, the public headrest is protected from potential damage from hair care products or the receipt of unwanted dirt or biological matter.

Thus, those of skill in the art of consumer products will readily recognize that hair protecting sleeve of the current invention provides a useful device to help reduce hair breakage and snagging during sleep as well as respond to one or more of the proposed needs noted above. Similarly, the hair protecting sleeve is also a useful travel accessory for safety and comfort. Users who don't like the idea of using someone else's pillow shams can slip the pillow sleeve over the existing pillow sham. Similarly obviously, the cushioning 190A noted in FIG. 10 may include inflatable cells, or the use of padding, foam or other material to improve user comfort.

While this description is directed to particular embodiments, it is understood that those skilled in the art may conceive modifications and/or variations to the specific embodiments shown and described herein. Any such modifications or variations which fall within the purview of this description are intended to be included as well. For instance, the sleeve does not have to be substantially cylindrical in shape. It may be made to taper in the back. It could have wavy or scalloped edges (FIG. 9). It could be in the form of a circle with bands to hold the circle in place (FIG. 8). Alternatively it could consist of two circles connected at the top and bottom.

In place of the circular device shown in FIG. 10 just about any shape could be used provided it is of a dimension to accommodate the head of the user. The shape could be held in place on the pillow using any available means including silk ribbons, hook and loop tapes, elastic bands, etc. The sleeve of the hair protecting device could be made to encircle the longer dimension of the pillow instead of going around the pillow top to bottom around the narrower dimension (FIGS. 6, 8).

Similarly, the hair protecting device may consist simply of a slippery material or it could have a backing material. It could also be padded for more comfort. Thus, even though the description above contains many specifics, these should not be construed as limitations on the scope of the invention, but rather as examples of preferred embodiment thereof.

In the claims, means- or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

1. A protective device, for engaging an external cushion member and protecting a users head, comprising:
at least a first pillow sleeve member having an inner surface and an outer surface;
means for securely engaging said first pillow sleeve member to said external cushion member, thereby minimizing displacement relative thereto during a use by said user; and
said outer surface being at least one of an increased friction surface and a reduced friction surface, whereby said protective device is readily adapted to a user demand.

2. A protective device mountable on an external cushion member for protecting a user's head, comprising:
a cover member for covering at least a portion of said external cushion member, said cover member having an inner cushion member engaging surface and a user head receptive outer surface; and
means for maintaining an engagement contact of said cover with said external cushion member thereby to inhibit relative movement between said external cushion member and said cover member responsive to a user head engagement with said cover member during a use period.

3. A protective device in accordance with claim 2, wherein:
said engagement contact maintaining means comprises a relatively rough material on said cover member inner surface.

4. A protective device in accordance with claim 2, wherein:
said cover member outer surface is a low friction material surface.

5. A protective device in accordance with claim 2, wherein:
said external cushion member includes a pillow, said cover member comprises a pillow sleeve encircling said pillow.

6. A protective device in accordance with claim 4 wherein:
said engagement contact maintaining means is carried on said pillow sleeve and operable to prevent unintended relative movement between said cover member and said external cushion member.

7. A protective device in accordance with claim 6, wherein:
a pillow sham piece is interposed between said pillow and said pillow sleeve.

8. A protective device in accordance with claim 5, wherein:
a structure of said pillow sleeve embodies one of a padding material and an absorptive material.

9. A protective device in accordance with claim 5, wherein:
said pillow sleeve embodies a moisture barrier between the inner and outer surfaces thereof.

10. A protective device in accordance with claim 5, wherein:
said pillow sleeve embodies one of an anti-organism shield and a biological shield at its inner surface.

11. A protective device in accordance with claim 5, wherein:
said engagement contact maintaining means comprises one of elastic bands, ribbon ties, VELCRO strips, and an elastic stretch material.

12. A protective device in accordance with claim 11, wherein:
said pillow sleeve includes a continuous outer member joined at outer member opposite ends with a band an elastic stretch material whereby said pillow sleeve is caused to snugly fit about said pillow.

13. A protective device in accordance with claim 11, wherein:
opposite ends of said pillow sleeve are secured with ribbon ties whereby said pillow sleeve is caused to scrunch thereby reducing pillow sleeve length therewith to cause said sleeve to snugly fit about said pillow.

14. A protective device in accordance with claim 5, wherein:
said pillow is configured of ovoidal shape, said pillow sleeve being of an elastomeric whereby it is stretchable to conform with said pillow ovoidal shape.

15. A protective device in accordance with claim 2, wherein:
said external cushion member is a pillow, said cover member being disposed at only one-user surface of said pillow, said engagement contact maintaining means comprising extending members projecting from opposite sides of said cover member in a course passing around said pillow for engaging with corresponding extending members at opposite sides of said cover member for loop tying therewith.

16. A protective device in accordance with claim 5 wherein:
said pillow sleeve includes an inner reduced friction region bounded at each of opposite sides thereof by regions of absorptive material.
